(19) United States
(12) Patent Application Publication
(10) Pub. No.: US 2003/0144956 A1
(43) Pub. Date: Jul. 31, 2003

(54) System and method for capturing payments data onto uniquely identified payer-carried chips for periodic upload and download with institutions

(76) Inventors: Mason K. Yu JR., Walnut Creek, CA (US); Gregory J. Yu, Hillsborough, CA (US)

Correspondence Address: Global Law Group, Suite 200, 1601 Bayshore Hwy., Burlingame, CA, 94010, US

(21) Appl. No.: 10/058,618

(22) Filed: Jan. 28, 2002

(51) Int. Cl. G06F 17/60

(52) U.S. Cl. 705/42

(57) ABSTRACT

Uniquely identified chips on portable payment devices can categorize customer transactions under universal sets of expenditure categories for household and business use based on certain characteristics of card readers that process payments. The expansive storage on the payment cards allows holders to upload batched transaction data derived from prior payment transactions by interfacing the cards into on-site and off-site ATMs that are linked to their card issuer or financial institution. Similarly, those same cards can use the properly linked ATM to download from the institution categorized payments data onto the storage medium inside the cards. This data would then be transferred through a card reader into the holder's own maintained transaction databases residing in a PC, laptop or other enabling appliance in her possession. To facilitate unique global addressing of card, card readers, and holders themselves, each component of the extended payment network all the way to the payer is identified with a unique global network addresses. This enhances overall security within the economy as well as efficient flow and assignment of categorization labels to payment transactions.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### 37 C.F.R. 1.71 AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office records, but otherwise reserves all copyright rights whatsoever.

### BACKGROUND

1. Field of Invention

The present invention relates to a system and method of uniquely identified payment devices to universally categorize payments and exchange transaction data between payment devices and financial institutions through ATM networks.

2. Description of Prior Art

For purposes of this description, “chip” is any integrated circuit microchip that can store and process data affecting a payment initiator. A “card” includes any portable, embossed device free of any physically attached connector that contains in its substrate a means, including a chip, to electronically store and process information. An ATM is an automated teller machine or automated transaction machine that is designed to accept and read an electronic chip or card and operates by design without any human intervention other than by the carrier.

Prior art to the present invention covers two principal areas, the automatic teller machine (ATM), and a card with an embedded integrated circuit chip, known as the smart card or the chip card. ATMs are nearly ubiquitous in many countries. Cards throughout the world are reaching monumental proportions.

ATM Usage and Functions

In the U.S., approximately 324,000 ATMs now bring banking closer to the customer. With interbank access among ATMs, holders of an access card can bank and transact from almost anywhere. Annually, there are about 1.3 billion ATM transactions. Research shows that most customers use an ATM anywhere from two to four times per month. Online bankers use the ATM roughly 11 times each month, partly because online bankers from home cannot make deposits and withdrawals for paper-based items.

Traditional functions of ATMs are cash withdrawals, deposits, fund transfers and balance queries. Those remain as powerful reasons to bypass teller lines during business hours or to transact 24×7 whenever convenient for the customer. Still, the principal convenience of an ATM to a customer remains as the easy, secure access to currency. Witness the recent conversion of Western European currencies into the euro. On Jan. 1, 2002, these market economies converted to the euro, and ATMs reached an all-time high in single day usage as economic units rushed to obtain the new euro bills.

ATMs have expanded their functionality to create greater profitability for ATM owners, which include both retail and banking firms. In the push for more versatility, banks have Web-enabled ATMs to promote goods and offer services, such as postage stamps and downloaded music. Self-service machines run in cost anywhere from $5,000 for a cash-only ATM all the way to $50,000 for a state-of-the-art ATM. Although these newer ATMs resemble PCs in functionality, banks realize that extended waiting time in the ATM line burdens their customer. This would otherwise defeat the mantra of the ATM's goal of speed to transact and withdraw money.

To date, ATMs have a myriad of patents that address multifunctionality. U.S. Pat. No. 6,308,887 issued to Korman, et al., in 2001 anticipates the use of nearly unlimited “standard” and proprietary protocols and certain sensors so that the transaction machine network can process all kinds of transactions. The claims do not cover the use of smart card sensors for any purpose in an interface with the ATM. U.S. patent application Ser. No. 20010014881 of Drummond et al. published on Aug. 16, 2001 contains two claims relevant to prior art. One covers a method to use an ATM with a card interface to change the stored value on a smart card and a second is an ATM that reads an account number from a card. However, these claims do not extend to uploading to the institution operating the ATM or to downloading onto the card itself generalized transaction histories of the cardholder. U.S. patent application Ser. No. 20010013551 of Ramachandran published on Aug. 16, 2001 claims a portable device to transfer and import cardholder information onto a single card. This includes a device to operate an ATM and transfer stored values on smart cards. The claimed apparatus related to smart cards is dedicated to adjusting stored values only.

Many banking functions are now available through personal ATMs. VeriFone Personal ATM™ is one such device. With a serial port connecting a reader with a consumer device or appliance, the owner uses a chip card (smart card) to initiate a wide variety of transactions. Multiple applications include electronic cash withdrawals, bill payment, stored value (electronic purses), retail purchases, fund transfers, electronic commerce, portfolio management and other user-authenticated transactions. As long as there is connectivity, the consumer can freely transact at home, at the office, in a public location, at a kiosk, or at a merchant's place of business.

The merchant point-of-sale (POS) terminal can perform bank-like ATM functions. U.S. Pat. No. 5,992,570 issued to Walter, et al. in 1999 is a self-service POS ATM unit. The claimed apparatus allows a user purchasing items at a merchant to independently scan and pay for items without store assistance. The POS unit also performs a variety of bank-like ATM functions, including cash withdrawals, cash deposits, interaccount transfers and balance queries. Although the preferred embodiment includes use of a chip card for payment, the novelty does not extend to upload of payment categorization data to the bank or download of the same onto the chip card.

Thus, nearly all prior art on ATM design and usage focuses on one-way transmission of traditional banking information. When money is tendered, the ATM dispenses a desired good or service as the customer executes an authenticated instruction (e.g., password protection). In fact, the universal upload of card information from the read-only memory (ROM) is typically limited to the card identity, holder identity and some means of authentication. Beyond this information, the card may upload a remaining balance for stored value balances, otherwise known as an electronic purse. Normally, financial institutions do not use their ATM networks to capture card transaction histories, except for cash withdrawals and debits. One-way channel delivery strategy forces the Internet banking customer to download critical banking information into their own stationary or portable computer device or system. The chip card can change all that.

Chip Card Usage and Components

Smart or chip cards throughout the world offer features affecting nearly every facet of commerce. Cards are used for secured access, identification, mass transit, and payment transactions within a closed or semi-closed environment. Accordingly, prior art on chip cards is enormous. Chip cards boast tremendous storage and processing power in view of their cost and compact size. The embedded microchip allows cards to operate in a variety of networking environments. In theory, this technical capability allows a card processing infrastructure to sharply curtail the number of cards an economic unit needs to carry.

Countries, such as France and Venezuela, have made the chip card nearly universal for their citizenry. The total number of chip cards manufactured for use within the United States and Canada rose from approximately 20 million in 1999 to about 28 million in 2000—a 37% growth. The fastest growing market segment was circulation in the financial market sector, with a 244% growth rate. Still, this amounts only to chip cards with chips in circulation, as opposed to actual demand for and usage of data on that embedded chip. As the case is in the U.S., reduction of fraud and other benefits related to payments are achieved only when a sufficient mass of networked readers can accept and read the chip card.

Chip cards appear in two versions for technical functionality. The basic version contains a microcontroller semiconductor device that performs computations, secured data storage, encryption and decision making. A microcontroller acts much like a PC's central processing unit, with a microprocessor, memory, and other functional hardware elements. A very smart card has a battery that charges and retains power when connected with a terminal device.

The weakness in prior art for electronically driven payments is demonstrated by tracing the emergence of technology in the payments process. The primary dual functions of payments are authentication and transmission of value. Only one payment form dispenses with both functions instantaneously—the delivery of currency (absent counterfeiting needs no authentication of the holder and the transmission of value is simply the currency's face value. The magnetically-encoded stripe card then arrived. This card authenticates the holder, but verification is limited to efforts at POS. Verification includes signatures, Personal Identification Numbers (PINs), and biometric methods. Magnetic strip cards already are vulnerable to extensive fraud. Now, with online commerce, authentication creates a new fraud exposure

Chip cards can enhance safety for their authorized holders and merchant-payees. No matter what type of card is presented, there must be an electronic reader. Chip card readers are now not only prevalent among merchants at POS, but are installed within ATMs owned by banks and stationed either on-site or off-site. To enable consumers and businesses to transact independent of personal merchant participation, chip cards can now be read by holder-managed devices, including PC-connected readers, mobile phones, phones, and other consumer appliances.

The opportunity among prior art for chip cards and chip card readers is not readily discerned. Chip cards are only one of many choices for payment authentication, but they do offer greater security and privacy. Even the use of a card for authentication in payments is now in question, at least in online transactions. Single use “credit card” numbers are now available for authentication, with the initial log-in done with the chip card. The singular advantage of the chip card is dynamic exchange and storage of data, which occurs as soon as the card is accepted by the reader. As the cost of chip cards continues to fall, multiple applications become more promising. However, this cost is directly dependent on the amount of storage capacity required by the chip card manufacturer to perform the desired functions and applications.

The Problem of Multiple Cards for Holders

In today's payment environment, a frequent card payer is challenged to sensibly manage card-generated payment transaction data from numerous cards. The holder has multiple cards—credit cards, debit and ATM cards, phone cards, transit cards, gift cards, loyalty cards, and merchant cards. Transactions at POS sometimes print a statement, sometimes they do not. The holder can attempt to maintain tedious records, but she must comb through monthly mailed or electronically transmitted statements to her PC with the mass of slips accumulated at POS. If she is an active Internet shopper, printers typically generate letter-sized paper and not the typical register receipt or charge slip. Each month, proper data capture must emerge from paper receipts from a multitude of readers, printers, appliances, and devices, in addition to electronically processed, paperless transactions.

The proliferation of multiple cards with multiple functions is an ongoing burden to the economic unit. In the magnetic stripe market, prior art attempts to consolidate the replication of cards. In the invention described in U.S. Pat. No. 6,189,787 issued to Dorf in 2001, the prior art is the creation of multifunctional cards. This invention, however, is limited to the magnetically-encoded striped card and does not contemplate chip cards. Further, it does not give any issuer or merchant an incentive to surrender loyalty benefits of a dedicated card and separate branding.

Prior art on smart cards emphasize the combination of multiple applications, including payment, onto one card. Without government mandate, merchants and card issuers as well as vendors on competing platforms find few advantages in collapsing the branding and purchasing power on the same card. The proliferation of smart card readers has no clear benefit to the economic unit unless it can either use multiple applications and/or capture transaction data in a standardized format for financial management. Transaction, loyalty, payment, credit and debit, and ATM cards all compete for space in the wallet. These cards fall in cost of production for the issuer as long as the data storage capacity is as low as possible. Issuers find few advantages in allowing other merchant data to occupy the card. This leaves the economic unit without a universal merchant-issuer card that is interoperable for transaction data capture.

Chip Card Data Capture

Prior art allows smart cards to capture and present transactional data to the holder, but no universal system of indexing and categorization exists to benefit the holder. Three patents are relevant on recording transactional data onto smart cards. None remove the laborious task of initially categorizing such data. U.S. Pat. No. 5,649,118 issued to Carlisle et al. in 1997 provides for consolidating transactional capability with multiple merchants onto a single card carrying suitable firewall security on the same chip. This does not provide for movement of all transactional data to a single merchant or bank for further processing or analysis for the benefit of the holder. U.S. Pat. No. 6,129,274 issued to Suzuki in 2000 presents a novel means to have the chip card capture transactional data at POS. This data is downloaded to the holder's PC but not uploaded to an institution.

U.S. Pat. No. 5,859,419 issued to Wynn in 1999 intends to consolidate multiple account transaction activity with a single chip card. This prior art recommends the use of categories for the convenience of the cardholder. However, assignment of a category to a transaction or payment is purely discretionary and left to the holder to use their PC or other device. This task is not delegated up to their financial institution, card issuer, or merchant.

U.S. Pat. No. 5,559,313 issued to Claus, et al. in 1996 comes the closest in concept to the present invention. The chip card tracks individual purchased items and categorizes them with a series of translation tables. There is no card reader-centric categorization code that assists in the translation. The holder's PC extracts transaction data in tabular format for further use and presentation to the holder. However, there is no upload of that data to the holder's bank or card issuer for processing and subsequent return of a report to the holder.

Even if the chip card captures spending data at point-of-payment, the holder still must download that data and use personal financial management (PFM) software. If the holder decides to shift that burden to the financial institution, that channel requires active use of a PC or other Internet device requiring either time-consuming connection step or the more expensive, always-on connection. A more efficient, electronically seamless channel must exist, and a financial institution could assume that task for the economic unit/cardholder. This would unify the capture and presentation of payment data, particularly if the financial institution is a trusted source and prepared to leverage the opportunity.

Expenditure Tracking by Cards

Expenditure tracking for households and businesses is achieved through a variety of patented and non-patented PFM tools. PFM tools include Pocket Quicken® that runs on a Palm Pilot. The stylus is faster to enter transactional data than the manual method. However, this solution does not electronically connect the POS terminal with the handheld PDA. A proper solution would remove any manual movement or involvement by the customer other than presenting the chip card for payment processing.

Online access devices such as credit cards and debit cards authorize payment with an embossed account number on one side and a magnetic stripe containing account information in machine-readable form on the other side. Debit cards deduct funds directly from the end user's bank account using an ATM or POS terminal. With either type of card, the merchant handling the transaction has a relationship with the bank and card association. Credit card associations have traditionally offered expenditure classification for cardholders. The production of such card data relies solely on the merchant's identity, i.e., its standard industry classification (SIC) code.

Credit card associations and providers, such as Visa, MasterCard, and American Express all provide periodic classification of charges on a periodic basis for individual and corporate cardholders. However, those summaries are incomplete in two key aspects. First categorization is forced upon the cardholder based on the identity of the merchant, which may sell multiple types of goods and services. The more critical problem is that the only categorized transactions are those processed by the network. Average Americans carry at least five, sometimes even 10 charge cards. Therefore, only manual or keyed-in consolidation of categorized expenditure is available. Categories are not universal among various card products. Nor are card payments automatically consolidated.

Another patent, U.S. Pat. No. 5,748,908 issued to Yu in 1998, tracks expenditures made with credit cards and debit cards and sends the data through the network, but does not contemplate a card carrying multiple merchant data capture capability to store categorized data on a single card.

Individual economic units cannot accurately track their spending without PC use or extraordinary manual effort to sort and aggregate transactions with cash, checks, credit cards, debit cards, smart cards and electronic devices. Even if individualized payment management through PFM software is reliable, no efficient channel exists to collect data that resides on home PCs and laptop computers.

The prior art carries no effective and uniform means to uniquely identify cards. U.S. Pat. No. 6,189,787, issued to Dorf in 2001, proposes various types of cards, each with a unique identification number approved for use by the American Banking Association. The restrictions on utility are obvious. The numbering system may not provide a unique, universal address recognized globally. Further, the address might not be readily convertible or usable within an Internet environment where communication must be rapid and targeted.

Overall, the prior art does not give economic units paying by card a standardized, user-friendly categorization tool resting within a single, uniquely addressed card that can efficiently and conveniently send that data for management by the holder's financial institution or to the holder's own managed database.

### SUMMARY OF THE INVENTION

It is an object of the present invention to establish a pervasive global network addressing system for all essential components of the card payment network beginning with the payment device carried by its holder to the networked electronic junctions to the terminal destination where transaction data resides within an institution.

It is a further object of the present invention to logically assign within a card network to each and every ATM/POS reader a universal expenditure (UEX) code within a numerical range of the UEX code assignments. The logical mapping for each and every such ATM/POS reader is achieved via a telecommunications network programming the internal operating system of each ATM/POS reader.

It is still another object to enable merchant-managed chip card readers and cardholder-managed chip card readers with assigned UEX codes to automatically categorize card payment transactions during the time of interface between the merchant and the cardholder. Another object of the invention is to utilize a multi-application chip card to record and store card payment transaction data when payments are made at merchant POS terminals or user-managed computer device-connected card terminals.

An additional object of the invention is to allow a holder to carry a single chip card independent of all other cards to record and store payment transaction data that is categorized according to UEX codes.

A further object of the invention is to upload card payment transaction data through ATMs to the cardholder's financial institution.

A further object is to allow ATMs to download categorized payment transaction data maintained by a financial institution onto a cardholder's chip card, which can then download such data onto one's own computer device for further processing and reporting.

In addition, the present invention uses ATMs to print out a summary of categorized payment transactions initiated by the cardholder.

### DRAWINGS

In the drawings, closely related figures have the same number but different alphabetic suffixes.

FIG. 1 displays the card payment network layout to assign and maintain global network addresses for various components of the network.

FIG. 2 is a dynamic presentation of how data components of a card change when a transaction is processed by a card reader to assign a UEX code.

FIGS. 3A and 3B illustrate the upload and download of categorized transaction data through a chip card when inserted into a cash-dispensing ATM connected to the card holder's financial institution.

FIG. 4 is a diagram of prior art, U.S. Pat. No. 5,559,313, where a cardholder downloads categorized payment transaction data from a chip card to a holder-managed computer device.

FIG. 5 shows how global network addresses are assigned to various components of a card payment network, beginning with the card, cardholder, POS terminal, ATM, and user-managed card reader.

### DETAILED DESCRIPTION OF THE INVENTION

The Figures depict preferred embodiments of the present invention for purposes of illustration only. One skilled in the art will readily recognize from the following discussion that alternative embodiments of the structures and methods illustrated herein may be employed without departing from the principles of the invention described herein.

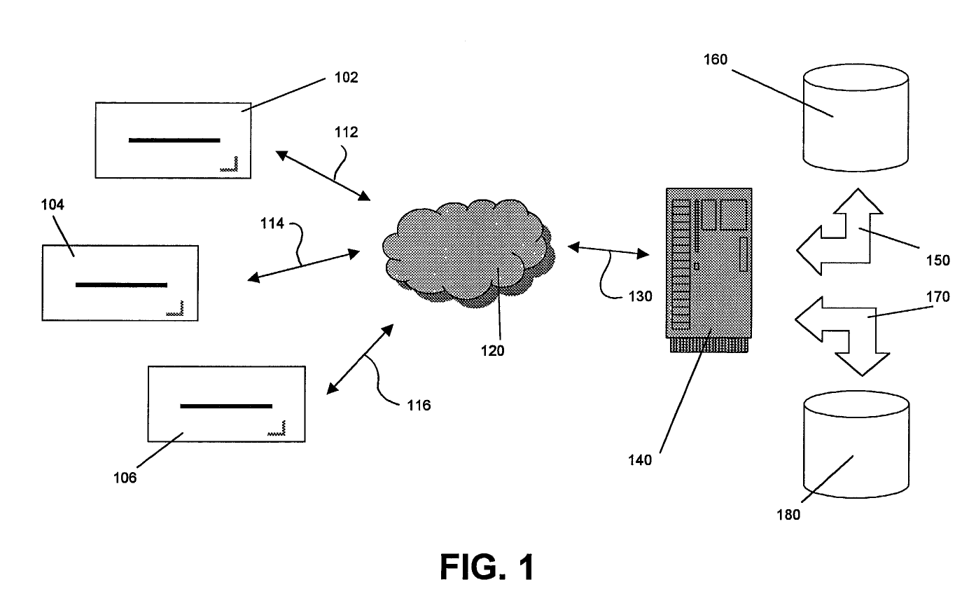

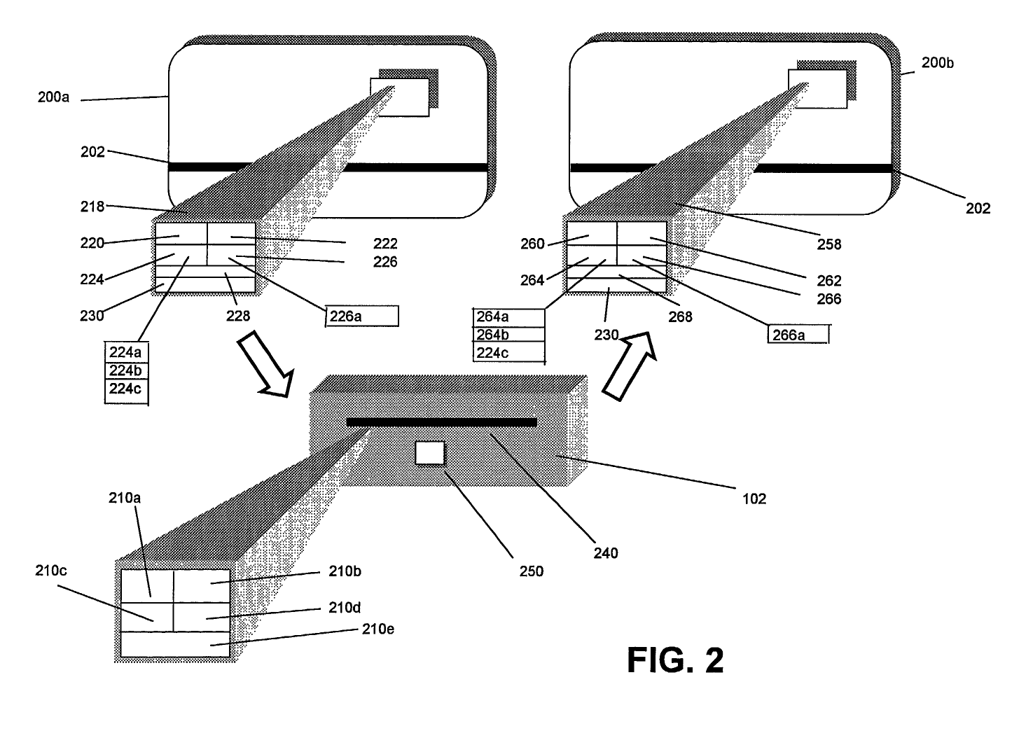

FIG. 1 shows one embodiment of the network to assign and maintain unique global network addresses to components of the network. Card readers 102, 104 and 106 are able to accept cards for reading, writing and payment processing. Card reader 102 may be a merchant's POS terminal that processes credit card transactions. Card reader 104 is a PC-connected device at cardholder's home. Card reader 106 is located inside a kiosk on a college campus. Through network 120, and wired/wireless connection 130, terminal database server 140 is able to monitor the location of card readers 102, 104, and 106 within the entire network. Through connection 150, terminal ID table 160 maintains a specific unique global network address for each of card readers 102, 104 and 106. Table 160 also contains a UEX code assignment program 210a from FIG. 2 for each card reader in the entire network. Through connection 170, terminal database server 140 accesses Internet protocol version 6 (IPv6) table 180. Next, terminal database server 140 assigns a UEX code for card readers 102, 104, and 106. Table 180 assigns unique global IPv6 addresses to each of the card readers and other essential components of network 120. For IPv6 address assignment in FIG. 1, database server 160 assigns and uniquely identifies card readers 102, 104, and 106. Card reader 102 might have an IPv6 network address of AA01:9090:1111:1212:0192:0168:0123:0101. Card reader 104 might be assigned an IPv6 network address of AA01:9090:1111:1212:0192:0168:0123:0203. Similarly, card reader 106 might be assigned a network address of AA01:9090:1111:1212:0192:0168:0123:0222. Each physical card reader requires only one unique address.

Terminal ID table 160 and IPv6 table 180 are components of a relational database. The logical key of this database is the logical terminal address. Since network 120 is made up of routers, switches and computers, the table lookup is done with a structured query language command known as a table join. For performance reasons and physical memory constraints, it is advisable to split a database into smaller manageable tables. In IPv6 table 180 there are two columns. One column is the primary key of the table that is the terminal ID address. The other column are the values of the IPv6 addresses. Within the 128-bit address, there is ample room for logically identifying latitude, longitude coordinates, store ID, country code, province, and department code. The nomenclature of the IPv6 address is 8 groups of 4 hexadecimal numbers. The eight groups are separated by seven colons altogether. The colons mean nothing to a computer or router, except to serve as a visual aid. As a shorthand notation, because of the expansiveness of the address one colon may substitute for one or more groups of 4 hexadecimal zeroes. For example, card reader 102 can have an IPv6 address of FFAE::090F. Card reader 104 can have address of BBBB::000C. Both of these addresses would appear as an entry in IPv6 table 180. Double colons are used between groups when there are one or more groups of consecutive sets of hexadecimal zeros. Further, double colons only appear once in an IPv6 address.

IPv6 is the most recent international data network addressing scheme being promulgated and logically augmented by the Internet Engineering Task Force (IETF). The IETF is composed principally of high technology firms such as Sun Microsystems and Cisco Systems. Other key members include Nokia, ATT and NTT of Japan. The IETF is responsible for laying down the networking Internet protocols (IP) such as FTP, POP, and SMNP so that computer systems around the work can communicate over the Internet. Without such fundamental standards in place, the World Wide Web is impossible. IP is the bedrock networking foundation based on an open set of standards that any computer vendor can choose to follow. In the late 1900's, proprietary networking protocols such as IBM's Systems Network Architecture (SNA) and Digital Equipment's DECNET made it possible for monolithic computer networks to be from one vendor only. As personal computers and LANs exploded in complexity and in network topologies and companies were consolidated and sold off, IT managers had to merge disparate networks and computer systems. This phenomenon, with the growth of Websites, led to the gradual exhaustion of IPv4 addresses, which in turn led to the birth of IPv6 addressing.

From the network perspective, if there is no common protocol between two different and geographically distinct data centers, there can be no efficient means of transferring accurately and swiftly other than bulk data transfer from magnetic tapes. For transaction-intensive computer systems, this is clearly unfeasible. IP allows overnight transfers of hundreds of thousands of transaction records into a corporate database. However, the proliferation and rapid ascendancy of the open IP standard known as IPv4 has caused a serious and potentially worldwide problem for government and corporate network planners. The IPv4 protocol is predicated on the well-known 32-bit addressing scheme. Based upon the binary arithmetic, 2 to the 32^{nd} power is exactly 4,294,967,294 unique host addresses. However, population growth and worldwide acceptance of mobile devices is quickly exhausting unique addresses. There are now an estimated one billion mobile phones in use. Since these and other electronic devices have no native intelligence, network architects demand that the next generation of Internet addresses accommodate the global requirement of uniqueness. Thus, the IETF has proposed a new set of Internet addresses known as the IPv6 . Technically, IPv4 despite its incumbency is the current Internet networking standard. Numerically, the IPv4 is a 48-bit addressing scheme. IPv6 addressing encompasses 6 bytes as opposed to the 4-byte IPv4 scheme. To give a relative magnitude of IPv4 addresses versus the proposed IPv6 addresses, the Ipv4 addressing scheme can barely handle the present day worldwide Internet addresses today. IPv6 can handle over 4 billion present day Internet IPv4 addressing schemes. Another more poignant mathematical analogy is that for each square meter of planet Earth, IPv6 can accommodate 1500 unique and distinct IPv6 addresses. Thus it is obvious that the present invention allows for generous IPv6 addressing of readers and cards to no matter what future growth may affect global payments environments.

Prior art network addressing schemes such as those based upon satellite radio frequency are inferior because they are analog by design. Technically, the radio transmission frequencies must be unique and the integrated circuits must translate a series of sinusoidal waves subject to unpredictable atmospheric conditions into a logically coherent binary stream. Witness the present day problems with cellular networks and the frequency of dropped calls for no apparent reason. Similarly, computer companies such as Microsoft have come up with a proprietary nomenclature of tagging computers. This may be fine within a computer network built exclusively around Microsoft operating systems, but this naming convention is ill-equipped for tagging computer devices, portable devices, and cards all connected via the Internet. The present invention avoids ambiguity and incompatibility of network address schemes and answers the crucial threshold of interoperability across borders.

FIG. 2 is a visual layout of the architecture of card reader 102. Its card slot 240 is where the cardholder inserts card 200a prior to the specific transaction. The internal components of card reader 102 include uniform expenditure (UEX) assigned code 210a, merchant ID 210b, network operating system 210c, IPv6 address 210d, and UEX assignment program 210e. Network OS 210c reads card 200a during the authorization process to read the cardholder's account and approve the transaction. For card reader 102, its UEX assignment program 210e accepts a single uniform expenditure classification for all transactions processed by card reader 102, unless and until it is re-programmed with a different UEX code. Terminal ID table 160 from FIG. 1 uses network 120 and network links 130 and 112 to pre-program card reader 102 with a single category selected from a set of UEX categories. One universal set is used for economic units that are households. Another universal set is used for business entities.

In the preferred embodiment, card 200a is a plastic, paper, polymer, or other non-metallic wallet-sized card that contains a read-write electronic component. Magnetically encoded stripe 202 on card 200a processes legacy transactions. Since magnetically-encoded stripes lack read-write programmability, a common choice is a card with an inserted programmable integrated circuit chip 218, also known as a microcontroller. Microcontroller chip 218 includes microprocessor 220, random access memory (RAM) 222, read-only memory (ROM) 224, non-volatile memory 226, and a card reader interface 228. Other elements of microcontroller 218 may include a clock, a random number generator, interrupt control, control logic, a charge pump, and power connections. Card reader interface 228 allows the card to communicate with various electronic devices. Microprocessor 220 is the CPU of card 200a. RAM 222 stores calculated results as stack memory. ROM 224 has the card's operating system, fixed data, standard routines, and look up tables. Non-volatile memory 226 (such as EPROM or EEPROM) retains information that is not lost when the card is not receiving current through card reader 102. Such information typically is changeable based on the card or other events, such as a card identification number, a personal identification number, authorization levels, cash balances, credit limits, etc. Card reader interface 228 includes the software and hardware necessary for communication with the outside world.

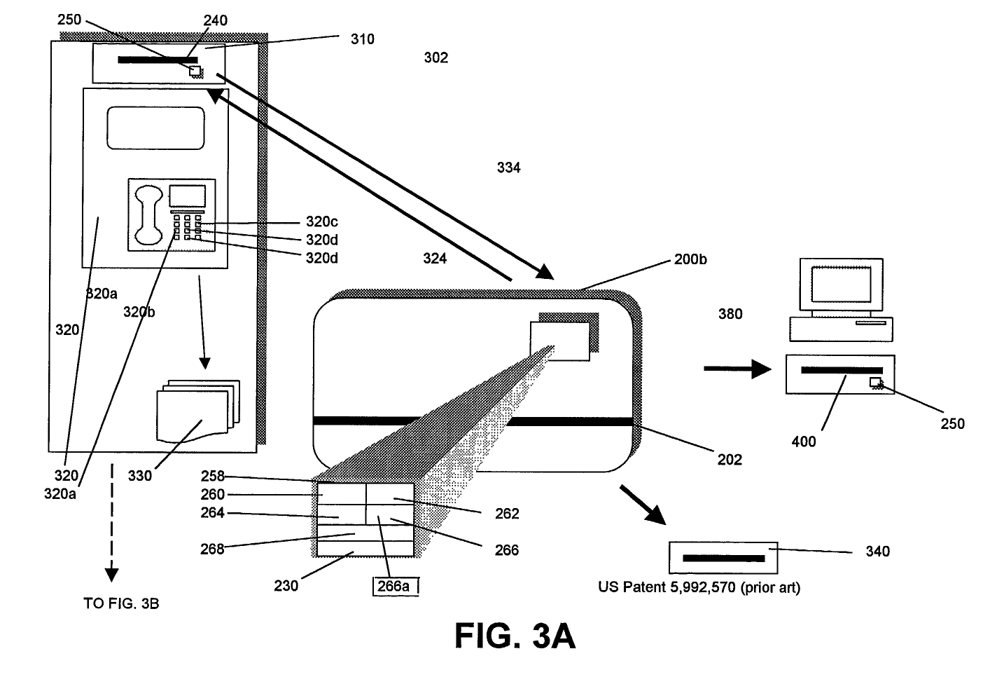

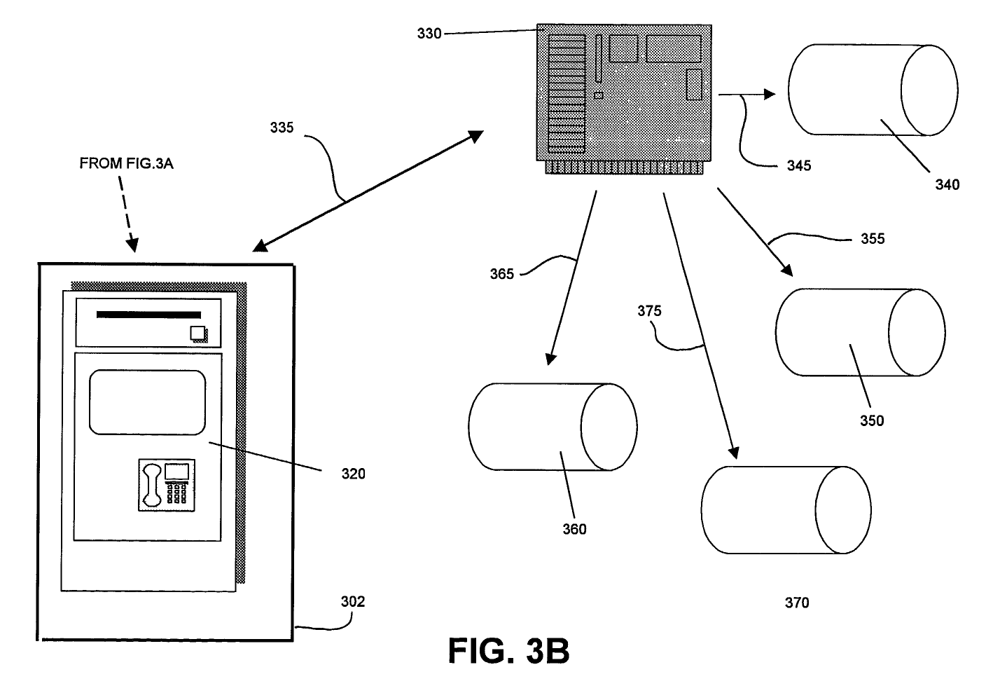

The preferred embodiment reaches into ROM 224 to add transaction field software logic 224a, UEX table 224b, and a permanent, unique and specific IPv6 global network address in IPv6 224c. With prior art, holder of cards carries many types of credit cards, loyalty cards, and membership cards in her wallet. Without promoting or discouraging the evolution of multifunctional smart cards, cardholder may use card 200a to record transactional and payments data, even if the card is not used for actual payment. In this sense, card 200a may act as an electronic register of all transactions conducted with any type of card, as long as card reader 102 can read and write onto card 200a. Nonvolatile memory 226 records and stores all such transactions. Later, in FIG. 3, such data is either uploaded or downloaded, which depends on cardholder's needs, and her financial institution's capabilities.

The present invention also acknowledges the practicality of wireless communications used between card 200a and card reader 102. Contact communications require that the cardholder or merchant slide card 200a into the physical slot 240 found in reader 102. This type of contact technology is found prevalent in PCMCIA type 2 and type 3 card slots in millions of laptops. Manufacturing tolerances allow for a snug and secure fit for transferring electrical signals between the card and the remaining circuit board. The short range, low power antenna 250 provides a contactless and wireless solution between card 200a and card reader 102. By using available surface mount technology and CMOS (complementary metallic semiconductor technology as a part of the physical makeup of chip 218, wireless communications can be performed without exorbitant signal loss. Sophisticated error correction algorithms can be borne by the card reader 102, as opposed to chip 218, to provide an asymmetric, yet reliable communications between the card 102 and the wireless antenna 250. Industry initiatives such as the Bluetooth 4 meter transmission range and the most robust WIFI 802.11 standards for wireless Ethernet demonstrate that wireless communications augment mobility, flexibility and timely convenience for the end user, merchant, and customer. Further advances of the contactless communications can be extrapolated to watches, calculators, PDAs, cell phones and practically any device that is lightweight, portable and requires relatively small amounts of electrical power to perform the necessary communications and calculations on behalf of the user or customer.

As technology advances, an alternative embodiment for microcontroller chip 218 in card 200adispenses with the use of an integrated circuit chip. Instead, storage would lie in the card 200a's substrate as a structural logical arrangement of molecular and atomic structures. This would provide even smaller and cheaper means for processing and storing data.

In an alternative embodiment, chips containing the suitable memory and processing power for payment transactions do not even need to reside on a card. As long as the chip is retained and managed by the payment initiator, it can reside on or within any other non-metallic medium under the possession and control of the initiator. It could lie in a key ring attachment, token, or piece of jewelry. As discussed above, card reader 102 need not have a physical slot as long as an optical beam can read the contents of the chip. Typically card payments initiated at POS allow convenience to the initiator when she surrenders card 200a briefly to the merchant for authorization through reader 102. Still, if the merchant carries a wireless chip reader, the alternative embodiment can reduce fraud because the payment initiator authenticate with the scan and immediately view the merchant's screen details of the actual authorized payment. In prior art, card swiping by the merchant outside of the presence of the payment initiator allows the merchant to save the carbon slip or record the card number for a future, unauthorized payment transaction.

The embodiment of card 200a can be an additional feature of a multiapplication chip card, particularly if issuance of the card becomes universal among a large population. Or, even if multiple cards do not, independent of this invention, consolidate into a single-card solution, card 200a may be totally independent and separately manufactured and circulated. This type of recording card 200a may be inserted immediately after the primary payment device has been used or presented by the payment initiator, whether by cash, check, payment card, etc. This embodiment can serve the dedicated use of an electronic payment register for the holder as an economic unit. Card 200a becomes a universal tool for payment data capture with a single requirement. The point-of-payment allows card 200b to record a UEX code, regardless if the payment channel was cash, check, wireless or other tool or medium for payment.

With a universal card network platform, special attributes can be attached to all transactions that are processed with the card and even those processed by the issuing bank on behalf of the holder in other bank payment channels used by the same holder. Returning to FIG. 2, after card 200a is inserted into card slot 240 and accepted by card reader 102, UEX code assignment 210a sends a signal to card transaction journal 226a for the particular uniform expenditure code for the specific transaction. Card 200b now contains in its non-volatile memory 266b the card transaction data that includes the expenditure code for the transaction.

With respect to each outstanding card 200a, non-volatile memory 226 stores and maintains card transaction journal 226a. If circulation of card 200a is limited to a single card for identification and payment purposes by its holder, card 200a may also serve as a unique and personal identification device for individuals worldwide.

In FIG. 3A, card 200b contains card transactions data residing in transaction journal 266a accumulated over a period of time. Holder of card 200b has a demand deposit account with financial institution 302, which has issued to holder card 200b. This card has ATM capability and houses chip 218 with a configuration according to FIG. 2. Non-volatile memory 266 in card 200b has a series of payment transactions, categorized according to UEX table 224b.

Holder of card 200b now has three choices to release categorized payment transaction data to a secure site for further processing. First, she may present card 200b to merchant 310 that has a POS terminal with smart card reader. Prior art includes merchant managed processing or self-service processing of the card transaction. Through telecommunications link 312, card 200b may be able to transmit the contents of transaction journal 266a. However, this embodiment may not be preferable, particular where merchant 310 does not perceive the need to assist holder's financial institution. Where holder chooses to undertake the work with a self-service checkout device under prior art (U.S. Pat. No. 5,992,570), the device does not contemplate uploading multiple transactions data to the bank. The communication is limited to authorization to access credit or payment for a single transaction in question, not for prior transactions.

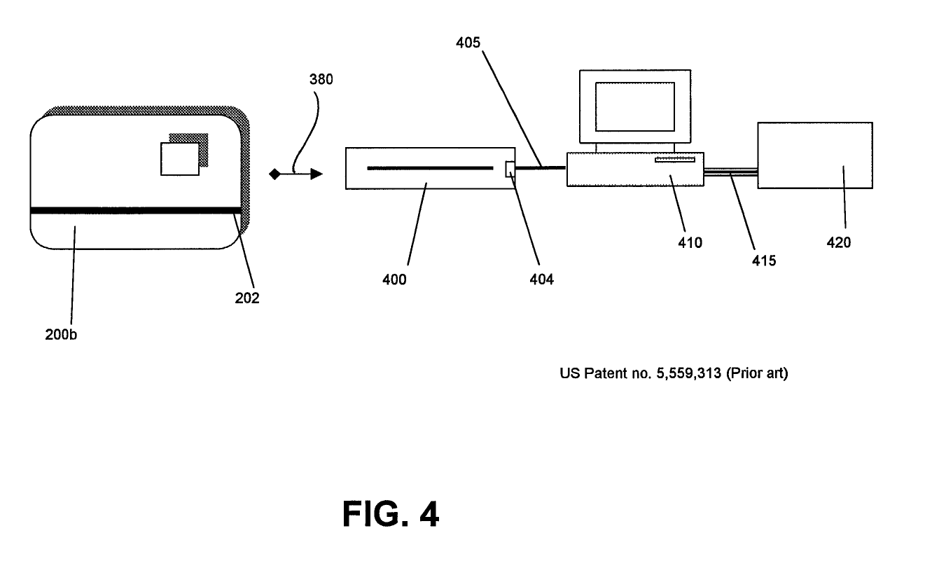

The second choice also contemplates prior art. Card 200b is inserted inside a portable or customer-managed chip card reader 400 that can read smart cards. FIG. 4 contains a partial layout of U.S. Pat. No. 5,559,313 issued to Claus et al. in 1996. Stored expenditure classifications associated with specific items purchased are available as data is passed into holder's PC, laptop, PDA or other consumer appliance. Holder uses personal financial management software to process and analyze such data and generate reports.

The third and final choice demonstrates the novelty and utility of the present invention. Financial institution 302 owns and maintains a multiapplication ATM that can read smart cards and more particularly, card 200b. Holder of card 200b seeks, more often than not, currency from ATM 320. ATM 320 can perform basic banking functions for holder of card 200b, who selects key 320a for deposits, 320b for withdrawals, and 320c for account balance inquiries. The key for 320d allows holder to conduct a variety of retail functions, such as purchasing stamps, entertainment tickets, and transportation cards.

By frequenting one of financial institution's ATMs for cash at least monthly, if not weekly, holder of card 200b is assured that with each trip to the ATM, the batched payment transactions data in payment transaction journal 226c are uploaded to her financial institution through upload process 324. If multi-purpose ATM 320 opens its data channel, this circumvents the time-consuming and tedious task of using holder's home PC to make an Internet connection to upload transaction data to the institution. Of course, the customer still retains the option of uploading through a device at home than can read transaction data off card 200b.

Similarly, card 200a with read-write capability will, when inserted into ATM 320, accept bank transaction data during download process 334, similar in purpose to process 324. Now holder of card 320 as an updated transaction file with which she may transfer it to card reader 400 attached to her PC or other holder-managed device.

FIG. 3B shows why uploading transaction data through the financial institution's ATM network is perhaps superior to using one's own Internet connection. An ATM data upload relies on the financial institution's own high-speed connection 335 (T-1 or higher) to transmit data. Upload process 324 in FIG. 3A is instantaneous and concurrent during a standard ATM transaction. In FIG. 3B, server 330 of financial institution directs data flow. Server 330 posts all card-uploaded transactions through link 345 into Demand Deposit Account Payment/Debit transaction database 340. If financial institution 302 is also the customer's card issuer, credit card transaction data inside the institution in database 360 can be returned to holder of card 200a during download process 334 while she conducts a transaction through ATM 320.

All the typical steps of transferring data into one's PC for these transactions are common prior art. Bank customer database 350 provides the logical link between the demand deposit account transaction database 340 and credit card transaction database 360. Upload process 324 and download process 334 in FIG. 3A are immediately commenced upon insertion of card 200a into card reader 310, as server 330's software interrogates customer account database 350 in order to retrieve the timely DDA transaction database 340 and debit/credit card database 360. This enables proper execution of download process 334 and upload process 324, which is for all intents and purposes simultaneous for the customer while she is engaged at the ATM.

Financial institution 302 may also use upload process 324 to capture all transaction data stored on card 200b, even for transactions not actually processed by the institution. The card 200a and ATM 320 interface allows the transfer of such data onto universal customer payment database 370 through link 375. This database sweeps in all payment transactions of customer, whether or not processed by institution 302, as long as a UEX code 266a has been assigned by server 330. Under prior art in U.S. patent application Ser. No. 09965100 filed by Yu, et al. in 2001, server 330 can apply a post-processing filter for payment transactions under universal expenditure categories for household and for business purposes. As transaction data is properly channeled inside financial institution 302 can use server 330 can assemble targeting marketing profiles to enhance their services to customers.

FIG. 4 is the prior art where card 200b is a smart card with tables on its chip for categorized payment transactions. Holder of card 200b inserts the card is process 380 into PC-attached card reader 400. Cable 405 connects the reader to customer's PC 410. U.S. Pat. No. 5,559,313 issued to Claus et al. in 1999 captures smart card classified payments and transfers the data into PC 410 for processing and analysis with PFM software, such as Money® or Quicken®. Personal printer 420, which is connected by printer cable 415 to PC 410 can generate printed summaries of categorized payments.

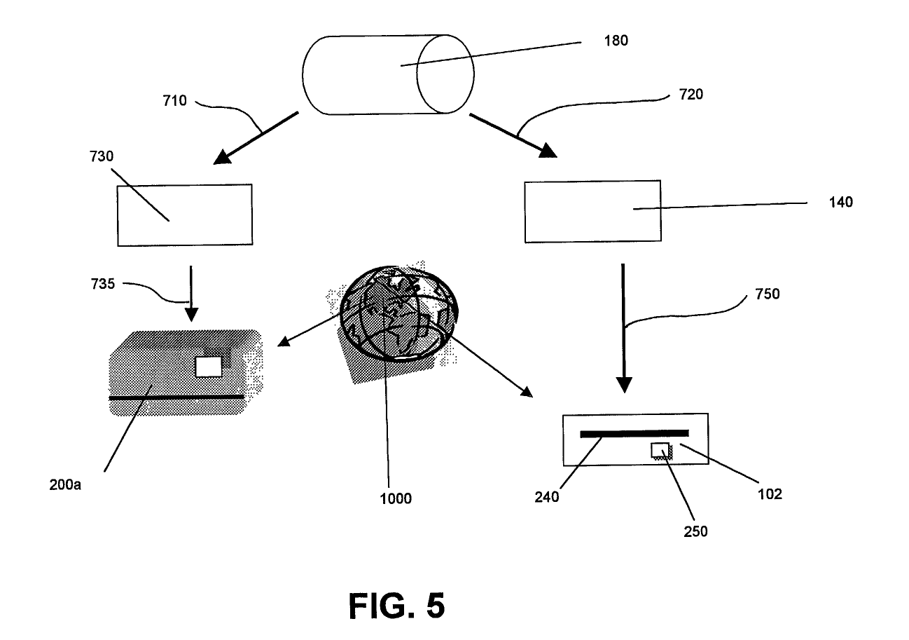

FIG. 5 shows the hardware and software components of the IPv6 addressing scheme as applied to the network of cards and devices within the present invention. Server 180 is the IPv6 address allocator and master repository of all IPv6 addresses used in the payment system. There will be a pool of available addresses to assign to each set of newly minted card 200a. For example, an arbitrary Ipv6 address might be CC00:0002:1111:5555:0222:0001:767A:2222. Once this address is assigned, server 180 will keep a separate database table for assigned IPv6 addresses for smart cards. IDE (Integrated Development Environment) 730 is readily available from Gemplus, Hypercom and VeriFone. The newly manufactured card 200a before a card customer uses it, will have burned into the non-volatile memory 226a the unique IPv6 address of BB.09.09.11.22.01. Similarly, IDE 140 may be from Hypercom, Ingenico (Fr) and VeriFone. The IDE 730 will download IPv6 address CC00:0002:1111:5555:0222:0001:767A:2222 onto non-volatile memory 224c on card 200a. This is done before the card from the cardholder's financial institution is sent for personal or business use. Globe 1000 contains the universe of assigned unique IPv6 network addresses. Conceivably, there can be several IPv6 addresses for each person, business establishment, legal entity, and economic unit, with an immutable IPv6 address for device and card they own and carry.

Wherever there is a human being as an economic unit, a single, uniquely addressed chip card may be assigned by a bank or government entity or ministry within each jurisdiction. Under the embodiment of the present invention, the security advantages to government and business of unique addresses for every person will need to be balanced against the legitimate privacy concerns of the individual.

This invention embodies using the uniqueness and extensibility of the IPv6 address as also a bona fide database key into a banking payment system. As described above, the Ipv6 address provides ample logical space to identify individual physical smart cards 200a and use the same key as a logical view port of the UEX tables for payment classification.

While the card system described herein is the preferred embodiment of the present invention, the claimed invention is not limited to the precise description in any way, and that changes may be made to the embodiment without limiting the scope of the invention as described in the claims that follow.

We claim:

1. A computer-based system, comprising:
a card means used by said cardholders to capture payment transaction data that contains a read-write electronic component selected from a group consisting of a programmable integrated circuit chip and a structural logical arrangement of molecular and atomic structures;
a card reader means to electronically communicate with one of a plurality of electronic devices selected from a group consisting of a point-of-sale terminal, automatic teller machine, PC, laptop computer, wearable computer device, wireless personal digital assistant, pager, cellular phone, stationary phone, cable television and consumer appliance;
a computer server means to accept and process payment transaction data stored by said card, generates periodic summaries of payments categorized according to at least one of a plurality of universal sets of expenditure categories native to a plurality of cardholders, and transmits said summaries to said cardholders using a plurality of means selected from a group consisting of postal mail, facsimile, wired electronic transmission, wireless transmission, Internet, satellite, cable, personal digital assistant, and television set-top box;
a database means to store said payment transaction data containing at least one of a plurality of expenditure categories within a universal set of expenditure categories assigned to each transaction; and
a communications network means to link said card reader means, said computer server means and said database means.

2. The system according to claim 1 wherein said card reader means throughout an interconnected card payment network are remotely, logically and electronically assigned, on a universal and global basis, at least one of said universal set of expenditure categories utilizing a telecommunications means.

3. The system according to claim 1 wherein one of said universal expenditure categories are assigned to said card reader means using a translation table based on the specific physical location of said card reader means using a plurality of indicators selected from a group consisting of staff position, employee identification, table, display case, counter, aisle, terminal number, check-out line, floor section, department of a store, store location, division of a firm, and physical street address.

4. The system according to claim 3 wherein said universal set of expenditure categories is related to household use.

5. The system according to claim 3 wherein said universal set of expenditure categories is related to business entity use.

6. The system according to claim 3 wherein said card reader means and said communications network means accepts exclusively transaction data emerging from said card means containing a magnetically encoded stripe.

7. The system according to claim 6 wherein said universal set of expenditure categories is related to household use.

8. The system according to claim 6 wherein said universal set of expenditure categories is related to business entity use.

9. The system according to claim 3 wherein said card reader means and said communications network means accepts exclusively transaction data emerging from said card means containing a read-write electronic component selected from a group consisting of a programmable integrated circuit chip and a structural logical arrangement of molecular and atomic structures.

10. The system according to claim 9 wherein said universal set of expenditure categories is related to household use.

11. The system according to claim 9 wherein said universal set of expenditure categories is related to business entity use.

12. The system according to claim 1 wherein one of said plurality of universal expenditure categories are assigned to said card reader means using a translation table based on a unique and specific structured global network hierarchy of addresses associated with said card reader means.

13. The system according to claim 12 wherein said universal set of expenditure categories is related to household use.

14. The system according to claim 12 wherein said universal set of expenditure categories is related to business entity use.

15. The system according to claim 12 wherein said electronic transaction network accepts exclusively transaction data emerging from said card means containing a magnetically encoded stripe.

16. The system according to claim 15 wherein said universal set of expenditure categories is related to household use.

17. The system according to claim 15 wherein said universal set of expenditure categories is related to business entity use.

18. The system according to claim 12 wherein said card reader means and said communications network means accepts exclusively transaction data emerging from said card means that contain a read-write electronic component selected from a group consisting of a programmable integrated circuit chip and a structural logical arrangement of molecular and atomic structures.

19. The system according to claim 18 wherein said universal set of expenditure categories is related to household use.

20. The system according to claim 18 wherein said universal set of expenditure categories is related to business entity use.

21. The system according to claim 1 wherein one of said plurality of universal expenditure categories are assigned to said card reader means using a translation table based on the identity of the owner of said card reader means.

22. The system according to claim 21 wherein said universal set of expenditure categories is related to household use.

23. The system according to claim 21 wherein said universal set of expenditure categories is related to business entity use.

24. The system according to claim 21 wherein said card reader means and said communications network means accepts exclusively transaction data emerging from said card means containing a magnetically encoded stripe.

25. The system according to claim 22 wherein said universal set of expenditure categories is related to household use.

26. The system according to claim 22 wherein said universal set of expenditure categories is related to business entity use.

27. The system according to claim 21 wherein said card reader means and said communications network means accepts exclusively transaction data emerging from said card means that contain a read-write electronic component selected from a group consisting of a programmable integrated circuit chip and a structural logical arrangement of molecular and atomic structures.

28. The system according to claim 27 wherein said universal set of expenditure categories is related to household use.

29. The system according to claim 27 wherein said universal set of expenditure categories is related to business entity use.

30. The system according to claim 1 wherein one of said plurality of universal expenditure categories are assigned to said card reader means using a translation table based on the identity of the merchant that utilizes said card reader means to process payment from said cardholders.

31. The system according to claim 30 wherein said universal set of expenditure categories is related to household use.

32. The system according to claim 30 wherein said universal set of expenditure categories is related to business entity use.

33. The system according to claim 30 wherein said card reader means and said communications network accepts exclusively transaction data emerging from said card means containing a magnetically encoded stripe.

34. The system according to claim 33 wherein said universal set of expenditure categories is related to household use.

35. The system according to claim 33 wherein said universal set of expenditure categories is related to business entity use.

36. The system according to claim 30 wherein said card reader means and said communications network means accepts exclusively transaction data emerging from said card means that contain a read-write electronic component selected from a group consisting of a programmable integrated circuit chip and a structural logical arrangement of molecular and atomic structures.

37. The system according to claim 36 wherein said universal set of expenditure categories is related to household use.

38. The system according to claim 36 wherein said universal set of expenditure categories is related to business entity use.

39. The system according to claim 1 wherein one of said plurality of universal expenditure categories are assigned to said card reader means using a translation table based on the general purpose of operations and existence of the party that utilizes said card reader means to process payment from said card holders.

40. The system according to claim 39 wherein said universal set of expenditure categories is related to household use.

41. The system according to claim 39 wherein said universal set of expenditure categories is related to business entity use.

42. The system according to claim 39 wherein said card reader means and said communications network means accepts exclusively transaction data emerging from said card means that contains a magnetically encoded stripe.

43. The system according to claim 42 wherein said universal set of expenditure categories is related to household use.

44. The system according to claim 42 wherein said universal set of expenditure categories is related to business entity use.

45. The system according to claim 39 wherein said card reader means and said communications network means accepts exclusively transaction data emerging from said card means that contain a read-write electronic component selected from a group consisting of a programmable integrated circuit chip and a structural logical arrangement of molecular and atomic structures.

46. The system according to claim 45 wherein said universal set of expenditure categories is related to household use.

47. The system according to claim 45 wherein said universal set of expenditure categories is related to business entity use.

48. A method for assigning to card payment transactions at least one of a plurality of expenditure categories within a universal set of expenditure categories native to a plurality of cardholders, the method comprising the steps of:
a) capturing card payment transaction records of said cardholders, each of said records containing at least cardholder identity, processing date and time of payment, amount of payment in local currency, and one or more categories selected from said universal set of expenditure categories;
b) transmitting said card payment transaction records through a communications network to reside in a database;
c) generating periodic summaries of payments by individual cardholders according to said universal set of expenditure categories; and
d) transmitting said summaries to said cardholders using a plurality of means selected from a group consisting of postal mail, facsimile, wired electronic transmission, wireless transmission, Internet, satellite, cable, PDA, and television set-top box.

49. The method according to claim 48 wherein said universal set of expenditure categories is related to household use.

50. The method according to claim 48 wherein said universal set of expenditure categories is related to business entity use.

51. A system of transmitting to a financial institution an expenditure category selected from a universal set of expenditure categories native to a plurality of cardholders, wherein said expenditure category is associated with card payment transactions initiated by cardholders who are customers of said financial institution, said system comprising:
a card means that contains a read-write electronic component selected from a group consisting of a programmable integrated circuit chip and a structural logical arrangement of molecular and atomic structures, wherein said card means stores card payment transactions data made by said cardholders consisting of at least date and time, transaction amount, identity of payee, and a selected expenditure category;
an electronic means to write onto said card means at least one of said expenditure categories for each of said card payment transactions, whereby said device is selected from a group consisting of a point-of-sale terminal, PC, laptop computer, wearable computer device, personal digital assistant, mobile phone, stationary phone, pager, cable television unit, and consumer appliance;
an automatic/automated transaction machine means to electronically communicate with a computer server of said financial institution, said machine means being able to perform at least two functions consisting of dispensing currency to said card holders without on-site human intervention by said financial institution, and receiving and accepting expenditure category data previously stored on said card means; and
a computer server means of said financial institution to accept and process payment transaction data generated by said cards, generates summaries of payments according to said universal set of expenditure categories, and delivers said summaries to said card holders using a plurality of means selected from a group consisting of mail, facsimile, wired electronic transmission, wireless transmission, Internet, satellite, cable, PDA, and television; and
a database means of said financial institution that stores said expenditure categories data.

52. The system according to claim 51 wherein after said card means are accepted by said automatic/automated transaction machine, buffer memory storage for payment transaction data that includes associated expenditure category data is cleared from said card means upon transfer of said payment transaction data by said automatic/automated transaction machine means into said database means of said financial institution.

53. The system according to claim 51 wherein said universal set of expenditure categories are related to household use by said plurality of card holders.

54. The system according to claim 51 wherein said universal set of expenditure categories are related to business entity use by said plurality of card holders.

55. A method for transmitting payment transaction data of cardholders who are customers of a financial institution, the method comprising the steps of:
a) capturing payment transaction records for storage onto cards with a read-write electronic component selected from a group consisting of a programmable integrated circuit chip and a structural logical arrangement of molecular and atomic structures, each of said records containing at least one of a plurality of data fields selected from a group consisting of cardholder identity, processing date and time of payment, amount of payment in local currency, and one or more categories selected from universal sets of expenditure categories native to a plurality of cardholders;
b) reading said payment transaction records with an automatic/automated teller machine that is linked to a card network to which said financial institution belongs;
c) recording said payment transaction records onto a database of said financial institution;
d) generating periodic summaries of said payment transaction records by individual cardholders according to said universal set of expenditure categories; and
e) transmitting said summaries to said cardholders using a plurality of means selected from a group consisting of postal mail, facsimile, wired electronic transmission, wireless transmission, Internet, satellite, cable, PDA, and television set-top box.

56. The method according to claim 55 wherein said universal set of expenditure categories is related to household use.

57. The method according to claim 55 wherein said universal set of expenditure categories is related to business entity use.

58. A system of receiving from a financial institution an expenditure category selected from a universal set of expenditure categories native to a plurality of customers, wherein said expenditure category is associated with payment transactions initiated through a plurality of payment channels selected from a group consisting of cash, paper check, electronic check, electronic bill pay and presentment, and automatic debit by customers of said financial institution through their demand deposit accounts, said system comprising:
a database means of said financial institution that stores said payment transaction data and expenditure categories data;
an automatic/automated transaction machine means that can electronically communicate with a computer server and said database means of said financial institution holding the demand deposit account of said customer, said machine being able to perform at least two functions consisting of dispensing currency to said card holders without on-site human intervention by said financial institution, and transmitting and writing onto said card means said expenditure category data previously stored in said database means of said financial institution;
a card means made available by said financial institution to said customers that contains a read-write electronic component selected from a group consisting of a programmable integrated circuit chip and a structural logical arrangement of molecular and atomic structures;
a card reader means that is able to read and write on said card means;
a database means maintained by said customer that stores said expenditure category data for transactions processed by said financial institution, whereby said database means resides on electronic devices selected from a group consisting of a PC, laptop computer, wearable computer device, personal digital assistant, mobile phone, stationary phone, pager, cable television unit, and consumer appliance; and
an electronic means to generate a summary of payments made by said customer according to said universal set of expenditure categories derived from said database means maintained by said customer.

59. The system according to claim 58 wherein after said cards are physically inserted into said card reader buffer memory storage for payment transaction data that includes associated expenditure category data is cleared from said cards upon acceptance of said payment transaction data using said card reader and said electronic device into said database means maintained by said customer.

60. The system according to claim 58 wherein said universal set of expenditure categories are related to household use.

61. The system according to claim 58 wherein said universal set of expenditure categories are related to business entity use.

62. A method for recording payment transaction data of customers of a financial institution which carry at least one card with a read-write electronic component selected from a group consisting of a programmable integrated circuit chip and a structural logical arrangement of molecular and atomic structures, the method comprising the steps of:
a) recording in a database of said financial institution a plurality of payment and debit transaction records of a plurality of its customers, each containing at least one of a plurality of data fields selected from a group consisting of customer identity, processing date and time of payment or debit, amount of payment or debit in local currency, and one or more categories selected from universal sets of expenditure categories native to a plurality of customers; and
b) writing onto said card, when inserted into or interfaced with an automatic/automated teller machine that is linked to a card network to which said financial institution belongs, said payment and debit transaction records.

63. The method according to claim 62 comprising the further steps of a) transmitting said payment and debit transaction records from said card through an electronic card reader into a cardholder-managed computer device and b) generating with said device periodic summaries of said records according to said universal set of expenditure categories

64. A system of utilizing a structured hierarchy of global network addresses selected from a group consisting of Internet Protocol version 4 (IPv4 ) and Internet Protocol version 6 (IPv6 ) to identify at least one of plurality of card means issued to a plurality of holders selected from a group consisting of persons, entities, businesses, government agencies and ministries, organizations, clubs, associations or any combination of the foregoing, said system comprised of:
a card means that contains in its substrate in a nonvolatile format one of said global network addresses to uniquely and permanently identify said card means, and additional data associated with holder of said card means;
a network means for organizing, maintaining and routing said global network address using a plurality of components selected from a group consisting of public telephone switches, routers, computers, digital transmission trunks, analog transmission trunks, satellite transmission, microwave transmission, and modems.

65. The system according to claim 64 wherein said system is able to perform at least one of a plurality of functions selected from a group consisting of global identification of holders, storage of demographic data, storage of financial transaction data, storage of medical data, storage of educational data, storage of employment data, payment processing, telecommunications, retail promotion, authorized access to physical locations, authorized access and use of computer systems, and authorized use of public means of transportation.

66. The system according to claim 64 wherein said card means utilize a universal set of expenditure categories native to a plurality of holders of said card means.

67. The system according to claim 66 wherein said universal set of expenditure categories is related to household use.

68. The system according to claim 66 wherein said universal set of expenditure categories is related to business entity use.

69. The system according to claim 64 wherein said plurality of card means utilizes as their non-volatile format magnetically encoded stripes.

70. The system according to claim 64 wherein said plurality of card means utilizes as their non-volatile format a read-write electronic component selected from a group consisting of a programmable integrated circuit chip and a structural logical arrangement of molecular and atomic structures programmable integrated circuit chips.

71. A system of utilizing a structured hierarchy of global network addresses selected from a group consisting of Internet Protocol version 4 (IPv4 ) and Internet Protocol version 6 (IPv6 ) to uniquely identify every member of a designated set of global electronic network components selected from a group consisting of public telephone switches, routers, computers, digital transmission trunks, analog transmission trunks, satellite dishes, microwave transmitters, and modems;
a) wherein said system is used to enable the processing of payment transactions through at least one of a plurality of automatic teller machine networks operated by at least one of a plurality of financial institutions; and
b) wherein said system is used to assign at least one of a plurality of expenditure categories chosen from a set of universal categories for at least one of a plurality of payments made by holders of cards that are used to for at least one of a plurality of functions selected from a group consisting of recordation, promotion, and authorization with respect to a payment transaction.

72. A system of utilizing a structured hierarchy of global network addressing schemes selected from a group consisting of Internet Protocol version 4 (IPv4 ) and Internet Protocol version 6 (IPv6 ) to uniquely identify the entire universe of global automatic teller machines that are operated by a plurality of intermediary transaction processors.

73. The system according to claim 72 wherein said global addressing schemes uniquely identify a designated subset of said entire universe of global automatic teller machines.

74. A system of utilizing a structured hierarchy of global network addressing schemes selected from a group consisting of Internet Protocol version 4 (IPv4 ) and Internet Protocol version 6 (IPv6) to uniquely identify the entire universe of global electronic point-of-sale devices operated by persons and merchants that accept payment, said devices selected from a group consisting of card readers, registers, terminals, handheld devices, and scanners.

75. The system according to claim 74 wherein said global addressing schemes uniquely identify a designated subset of said entire universe of global electronic point-of-sale devices.

76. A system of utilizing a structured hierarchy of global network addressing schemes selected from a group consisting of Internet Protocol version 4 (IPv4 ) and Internet Protocol version 6 (IPv6) to uniquely identify the entire universe of personal computers selected from a group consisting of desktop PCs, laptop computers, wearable PCs, and PDAs.

77. The system according to claim 76 wherein said global addressing schemes uniquely identify a designated subset of said entire universe of global personal computers.

78. A system of utilizing a structured hierarchy of global network addressing schemes selected from a group consisting of Internet Protocol version 4 (IPv4) and Internet Protocol version 6 (IPv6) to uniquely identify the entire universe of global electronic devices that facilitate two-way voice transmission, said devices being selected from a group consisting of land phones, cell phones, satellite phones, mobile phones, and video phones.

79. The system according to claim 78 wherein said global addressing schemes uniquely identify a designated subset of said entire universe of global electronic devices.

80. A system of utilizing a structured hierarchy of global network addressing schemes selected from a group consisting of Internet Protocol version 4 (IPv4) and Internet Protocol version 6 (IPv6) to uniquely identify the entire universe of global devices and components running an integrated circuits selected from a group consisting of public telephone switches, routers, computers, digital transmission trunks, analog transmission trunks, satellite dishes, microwave transmitters, modems, automatic teller machines, card readers, registers, terminals, handheld devices, scanners, desktop PCs, laptop computers, wearable PCs, PDAs, land phones, cell phones, satellite phones, mobile phones, and video phones.

81. The system according to claim 80 wherein said global addressing schemes uniquely identify a designated subset of said entire universe of global devices and components.
